(19) United States
(12) Patent Application Publication
(10) Pub. No.: US 2016/0255849 A1
(43) Pub. Date: Sep. 8, 2016

(54) Food Composition in Powder Form

(71) Applicant: DMK Deutsches Milchkontor GmbH, Zeven (DE)

(72) Inventors: Martin Diekhaus, Holdorf (DE); Carolin Drunat, Holdorf (DE)

(21) Appl. No.: 15/053,566

(22) Filed: Feb. 25, 2016

(30) Foreign Application Priority Data
Mar. 2, 2015 (EP) 15 157 263

(51) Int. Cl. A23C 9/16; A23G 9/32; A23G 9/40; A23C 1/08; A23G 9/34

(52) U.S. Cl. CPC A23C 9/16; A23C 1/08; A23G 9/34; A23G 9/40; A23G 9/327; A23V 2002/00

(57) ABSTRACT

What is proposed is a food composition in powder form, obtainable by subjecting a preparation comprising or consisting of
(i) carbohydrates,
(ii) lipids,
(iii) milk products and
(iv) emulsifiers
(a) first to a temperature treatment,
(b) homogenizing the temperature-treated product,
(c) concentrating the homogenized product,
(d) crystallizing the concentrated product,
(e) and freeing the crystallized product from residual water on a vacuum belt dryer.

The invention is situated within the field of milk products and concerns a food composition in powder form, more particularly an instant powder for producing ice-cream, a method for producing it and its use.

### PRIOR ART

Among the trends in the sector of the so-called “convenient food” articles is for the consumer no longer to buy foodstuffs in the specialist shop, but instead to prepare them themselves. The particular advantage lies in having these products available at any time, something which is particularly valued in the present age by young people with little time, in particular. This need, however, is in line with the requirement that the preparation of the products in question be simple and consume little time and that the results nevertheless necessarily conform to the results expected in the case of purchase within the specialist trade. It will be appreciated that these partly contradictory requirements place the manufacturers of such products in a situation of serious difficulty.

A typical example is the production of ice-cream: in the mid-winter, when the Italian ice-cream seller is taking his or her well-earned holiday in the home country, and the supermarket is closed at the weekend, there is a desire for nothing more than, for example, a fresh stracciatella ice-cream. Meeting this need requires sufficient eggs, sugar and cream to be found in the house. If that is the case, a sugar-egg mixture must first be prepared over a water bath, and then the beaten cream and freshly grated chocolate, fresh vanilla pulp and perhaps a shot of amaretto are added, after which the mass is homogenized, cooled and then introduced into an ice-cream maker. Even for a practised home chef, the preparation time is at least half an hour—in our present society, much too long, where everything is to take place at the touch of a button and directly. How much more practical, then, is it to open a ready pack, to dissolve the magic stracciatella ice-cream powder in water, and to place the mass directly into the ice-cream maker or else just beat it using a mixer.

And yet there is generally a great disappointment with the products of the prior art: the powders simply will not dissolve, instead caking together and requiring full mixer power for minutes to bring them into solution. The resulting preparation gives a fairly unappetizing visual impression, since the chocolate flakes not only look partially burnt but also taste like that. If the ready pack was purchased just a few weeks before, it now contains not a powder, but instead has formed into a solid block, owing to the high hygroscopic effect, a block which now must first be broken up. And when, after all of these adversities, your ice-cream is finally in the dish, you find that the flavour must have got lost along the preparation route, since the product has a sandy, insipid taste and in truth is good only for the waste bin.

Responsibility for this poor outcome lies not so much with the composition of the products as with the way in which the processed powders are produced. The nature of the dewatering, in particular, proves to be critical not only for sensory qualities and visual appearance, but also for solubility and stability on storage. It is necessary here in particular to avoid the known spray-drying techniques, as described for example in connection with the production of ice-cream powders in CN 101164426 A (SHENZHEN).

And it is at this point that the present invention comes in: the object was in fact that of providing preparations in powder form, particularly for the production of ice-cream, which are notable for a combination of outstanding solubility and stability on storage, which possess high flavour quality and colour stability, and which, in addition, are not hygroscopic.

### DESCRIPTION OF THE INVENTION

A first subject of the invention relates to a food composition in powder form, more particularly a readily soluble powder for producing ice-cream, which is obtainable by subjecting a preparation comprising or consisting of
(i) carbohydrates,
(ii) lipids,
(iii) milk products and
(iv) emulsifiers
(a) first to a temperature treatment,
(b) homogenizing the temperature-treated product,
(c) concentrating the homogenized product,
(d) crystallizing the concentrated product,
(e) and freeing the crystallized product from residual water on a vacuum belt dryer.

The initial preparations here may further comprise sweeteners, acidity regulators, thickeners, vitamins, prebiotic substances, antioxidants, fruit preparations, nuts, chocolates, flavourings, cocoa, honey, food colourings and the like.

A further subject of the invention relates to an analogous method for producing a food composition in powder form, by subjecting a preparation comprising or consisting of (i) carbohydrates,
(ii) lipids,
(iii) milk products and
(iv) emulsifiers
(a) first to a temperature treatment,
(b) homogenizing the temperature-treated product,
(c) concentrating the homogenized product,
(d) crystallizing the concentrated product,
(e) and freeing the crystallized product from residual water on a vacuum belt dryer.

Surprisingly it has been found that the preparations according to the invention provide a fully comprehensive resolution of the complex object outlined at the outset. The products are soluble spontaneously in water without attracting water from the air and swelling in the process. By virtue of the gentle production method, there is no adverse effect on flavour quality and there are no instances of discolouration. These advantageous properties are possessed by the products even when they have been stored for weeks.

Initial Preparations

The initial preparations include, as mandatory ingredients, carbohydrates, lipids, milk products and (food) emulsifiers.

Carbohydrates

Contemplated as carbohydrates, which form group (i), are the mono-, di- and polysaccharides which serve for or are at least beneficial to human nutrition. Substances used in particular here, accordingly, are those selected from the group consisting of glucose, fructose, dextrose and mixtures thereof. Use may also be made, at least partly, of dextrins. Dextrins or maltodextrins are starch breakdown products which in terms of their molecular size are situated between oligosaccharides and starch. They occur customarily in the form of white or pale yellow powder. They are obtained primarily from wheat, potato, tapioca and corn starch by means of dry heating (>150° C.) or with exposure to acid. Dextrin is produced in nature by Bacterium macerans, for example. Dextrins are also formed by the enzymatic breakdown of starch by means of amylase. Preferred dextrins are those having 5 to 20 and more particularly 6 to 10 dextrose equivalents (DE units).

Vegetable Fats

Vegetable fats form group (ii); they are understood to include not only hydrogenated but also partially hydrogenated or even unhydrogenated products. Particularly preferred are palm fat, coconut fat or mixtures thereof, obtained by hydrogenation of the corresponding oils.

Milk Products

Milk products, which form group (iii), encompass skimmed milk, whole milk, semi-skimmed milk, cream, whey, whey protein concentrates and mixtures thereof. The products can also be used in dry form: in other words, specifically, as spray-dried powders. In that case, however, the initial preparations must be mixed with water, forming a pumpable slurry which can be processed further.

Emulsifiers

Emulsifiers, which form group (iv), are notable for the important property of being soluble both in water and in fat. Emulsifiers generally consist of a fat-soluble part and a water-soluble part. They are always used when water and oil must be made into a stable, homogeneous mixture. Suitable emulsifiers that are used in the food processing industry are selected from: ascorbyl palmitate (E 304) lecithin (E 322) phosphoric acid (E 338) sodium phosphate (E 339) potassium phosphate (E 340) calcium phosphate (E 341) magnesium orthophosphate (E 343) propylene glycol alginate (E 405) polyoxyethylene(8) stearate (E 430) polyoxyethylene stearate (E 431) ammonium phosphatides (E 442) sodium phosphate and potassium phosphate (E 450) sodium salts of edible fatty acids (E 470 a) mono- and diglycerides of edible fatty acids (E 471) acetic acid monoglycerides (E 472 a) lactic acid monoglycerides (E 472 b) citric acid monoglycerides (E 472 c) tartaric acid monoglycerides (E 472 d) diacetyltartaric acid monoglycerides (E 472 e) sugar esters of edible fatty acids (E 473) sugar glycerides (E 474) polyglycerides of edible fatty acids (E 475) polyglycerol-polyricinoleate (E 476) propylene glycol esters of edible fatty acids (E 477) sodium stearoyllactylate (E 481) calcium stearoyl-2-lactylate (E 482) stearyl tartrate (E 483) sorbitan monostearate (E 491) stearic acid (E 570). Particularly preferred emulsifiers used are whole egg, egg yolk and mono- and diglycerides of edible fatty acids.

Further Auxiliaries and Additives

Contemplated as further auxiliaries and additives are, in particular, sweeteners, food acids, acidity regulators, thickeners, antioxidants, vitamins, fruit preparations, nuts, chocolate products, flavourings, vegetable/fruit powders, vegetable preparations, vegetable/fruit purées, cocoa, honey, true vanilla, ground vanilla pods, and also plant-based concentrates, extracts and oils and/or colourings.

Sweeteners

As sweeteners or sweet-tasting additives, firstly carbohydrates and especially sugars come into consideration, such as sucrose, trehalose, lactose, maltose, melezitose, raffinose, palatinose, lactulose, D-fructose, D-glucose, D-galactose, L-rhamnose, D-sorbose, D-mannose, D-tagatose, D-arabinose, L-arabinose, D-ribose, D-glyceraldehyde, or maltodextrin. Plant-based preparations that contain these substances are also suitable, for example based on sugar beet (Beta vulgaris ssp., sugar fractions, sugar syrup, molasses), sugar cane (Saccharum officinarum ssp., molasses, sugar cane syrup), maple syrup (Acer ssp.), honey or agave (agave nectar).

Consideration may also be given to

synthetic, i.e. as a rule enzymatically produced, starch or sugar hydrolysates (invert sugar, fructose syrup);
fruit and plant concentrates (e.g. based on apples or pears);
sugar alcohols (e.g. erythritol, threitol, arabitol, ribitol, xylitol, sorbitol, mannitol, dulcitol, lactitol);
proteins (e.g. miraculin, monellin, thaumatin, curculin, brazzein);
sweeteners (e.g. magap, sodium cyclamate, acesulfame K, neohesperidin dihydrochalcone, saccharin sodium salt, aspartame, superaspartame, neotame, alitame, sucralose, steviosides, rebaudiosides, lugduname, carrelame, sucrononate, sucrooctate, monatin, phyllodulcin);
sweet-tasting amino acids (e.g. glycine, D-leucine, D-threonine, D-asparagine, D-phenylalanine, D-tryptophan, L-proline);
other sweet-tasting low-molecular substances, e.g. hernandulcin, dihydrochalcone glycosides, glycyrrhizin, glycyrrhetic acid, derivatives and salts thereof, extracts of liquorice (Glycyrrhizza glabra ssp.), Lippia dulcis extracts, Momordica ssp. extracts or
individual substances, e.g. Momordica grosvenori [Luo Han Guo] and the mogrosides obtained therefrom, Hydrangea dulcis or Stevia ssp. (e.g. Stevia rebaudiana) extracts.

Food Acids

The food powders may contain carboxylic acids. Acids in the sense of the invention are preferably acids permitted in foods, especially those stated here:
E 260—acetic acid
E 270—lactic acid
E 290—carbon dioxide
E 296—malic acid
E 297—fumaric acid
E 330—citric acid
E 331—sodium citrate
E 332—potassium citrate
E 333—calcium citrate
E 334—tartaric acid
E 335—sodium tartrate
E 336—potassium tartrate
E 337—sodium-potassium tartrate
E 338—phosphoric acid
E 353—metatartaric acid
E 354—calcium tartrate
E 355—adipic acid
E 363—succinic acid
E 380—triammonium citrate
E 513—sulphuric acid
E 574—gluconic acid
E 575—glucono-delta-lactone

Thickeners

Thickeners are substances which first and foremost are able to bind water. Removal of unbound water leads to an increase in viscosity. Starting from a characteristic concentration for each thickener, in addition to this effect there are also network effects, which lead to a generally disproportionate increase in viscosity. It is said in this case that molecules ‘communicate’, i.e. “form loops”, with one another. Most thickeners are linear or branched macromolecules (e.g. polysaccharides or proteins), which can interact with one another through intermolecular interactions, such as hydrogen bonds, hydrophobic interactions or ionic relationships. Extreme cases of thickeners are sheet silicates (bentonites, hectorites) or hydrated SiO₂ particles, which are present dispersed as particles and can bind water in their solid-like structure or can interact with one another on the basis of the interactions described. Examples are:
E 400—alginic acid
E 401—sodium alginate
E 402—potassium alginate
E 403—ammonium alginate
E 404—calcium alginate
E 405—propylene glycol alginate
E 406—agar-agar
E 407—carrageenan, furcellaran
E 407—carob kernel flour
E 412—guar kernel flour
E 413—tragacanth
E 414—gum arabic
E 415—xanthan
E 416—karaya (Indian tragacanth)
E 417—tara kernel flour (Peruvian carob kernel flour)
E 418—gellan
E 440—pectin, opecta
E 440ii—amidated pectin
E 460—microcrystalline cellulose, cellulose powder
E 461—methylcellulose
E 462—ethylcellulose
E 463—hydroxypropylcellulose
E 465—methylethylcellulose
E 466—carboxymethylcellulose, sodium carboxymethylcellulose

Flavourings

The invention in particular also permits the use of flavourings with ester, aldehyde or lactone structure which are broken down particularly rapidly in the presence of titanium dioxide and under the influence of light. The invention therefore also ensures an enhanced stability, especially storage stability of the flavourings.

The food powders of the invention may comprise one or more flavourings. Typical examples include the following: acetophenone, allyl caproate, alpha-ionone, beta-ionone, anisaldehyde, anisyl acetate, anisyl formate, benzaldehyde, benzothiazole, benzyl acetate, benzyl alcohol, benzyl benzoate, beta-ionone, butyl butyrate, butyl caproate, butylidene phthalide, carvone, camphene, caryophyllene, cineole, cinnamyl acetate, citral, citronellol, citronellal, citronellyl acetate, cyclohexyl acetate, cymene, damascone, decalactone, dihydrocoumarin, dimethyl anthranilate, diethyl anthranilate, dodecalactone, ethoxyethyl acetate, ethylbutyric acid, ethyl butyrate, ethyl caprate, ethyl caproate, ethyl crotonate, ethyl furaneol, ethyl guaiacol, ethyl isobutyrate, ethyl isovalerate, ethyl lactate, ethyl methyl butyrate, ethyl propionate, eucalyptol, eugenol, ethyl heptylate, 4-(p-hydroxyphenyl)-2-butanone, gamma-decalactone, geraniol, geranyl acetate, grapefruit aldehyde, methyl dihydrojasmonate (e.g. Hedion®), heliotropin, 2-heptanone, 3-heptanone, 4-heptanone, trans-2-heptenal, cis-4-heptenal, trans-2-hexenal, cis-3-hexenol, trans-2-hexenoic acid, trans-3-hexenoic acid, cis-2-hexenyl acetate, cis-3-hexenyl acetate, cis-3-hexenyl caproate, trans-2-hexenyl caproate, cis-3-hexenyl formate, cis-2-hexyl acetate, cis-3-hexyl acetate, trans-2-hexyl acetate, cis-3-hexyl formate, para-hydroxybenzylacetone, isoamyl alcohol, isoamyl isovalerate, isobutyl butyrate, isobutyraldehyde, isoeugenol methyl ether, isopropylmethylthiazole, lauric acid, levulinic acid, linalool, linalool oxide, linalyl acetate, menthol, menthofuran, methyl anthranilate, methylbutanol, methylbutyric acid, 2-methylbutyl acetate, methyl caproate, methyl cinnamate, 5-methylfurfural, 3,2,2-methylcyclopentenolone, 6,5,2-methylheptenone, methyl dihydrojasmonate, methyl jasmonate, 2-methylmethyl butyrate, 2-methyl-2-pentenolic acid, methyl thiobutyrate, 3,1-methylthiohexanol, 3-methylthiohexyl acetate, nerol, neryl acetate, trans,trans-2,4-nonadienal, 2,4-nonadienol, 2,6-nonadienol, 2,4-nonadienol, nootkatone, delta octalactone, gamma octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl isovalerate, piperonal, propionaldehyde, propyl butyrate, pulegone, pulegol, sinensal, sulphurol, terpinene, terpineol, terpinols, 8,3-thiomenthanone, 4,4,2-thiomethylpentanone, thymol, delta-undecalactone, gamma-undecalactone, valencene, valeric acid, vanillin, acetoin, ethylvanillin, ethylvanillin isobutyrate (=3-ethoxy-4-isobutyryloxybenzaldehyde), 2,5-dimethyl-4-hydroxy-3(2H)-furanone and derivatives thereof (here preferably homofuraneol) (=2-ethyl-4-hydroxy-5-methyl-3(2H)-furanone), homofuronol (=2-ethyl-5-methyl-4-hydroxy-3(2H)-furanone and 5-ethyl-2-methyl-4-hydroxy-3(2H)-furanone), maltol and maltol derivatives (here preferably ethyl maltol), coumarin and coumarin derivatives, gamma-lactones (here preferably gamma-undecalactone, gamma-nonalactone, gamma-decalactone), delta-lactones (here preferably 4-methyl deltadecalactone, massoia lactone, deltadecalactone, tuberolactone), methyl sorbate, divanillin, 4-hydroxy-2(or 5)-ethyl-5(or 2)-methyl-3(2H)-furanone, 2-hydroxy-3-methyl-2-cyclopentenone, 3-hydroxy-4,5-dimethyl-2(5H)-furanone, acetic acid isoamyl ester, butyric acid ethyl ester, butyric acid-n-butyl ester, butyric acid isoamyl ester, 3-methyl-butyric acid ethyl ester, n-hexanoic acid ethyl ester, n-hexanoic acid allyl ester, n-hexanoic acid-n-butyl ester, n-octanoic acid ethyl ester, ethyl 3-methyl-3-phenylglycidate, ethyl 2-trans-4-cis-decadienoate, 4-(p-hydroxyphenyl)-2-butanone, 1,1-dimethoxy-2,2,5-trimethyl-4-hexane, 2,6-dimethyl-5-hepten-1-al and phenylacetaldehyde, 2-methyl-3-(methylthio)furan, 2-methyl-3-furanthiol, bis(2-methyl-3-furyl) disulphide, furfuryl mercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, 2-acetyl-1-pyrroline, 2-methyl-3-ethylpyrazine, 2-ethyl-3,5-dimethylpyrazine, 2-ethyl-3,6-dimethylpyrazine, 2,3-diethyl-5-methylpyrazine, 3-isopropyl-2-methoxypyrazine, 3-isobutyl-2-methoxypyrazine, 2-acetylpyrazine, 2-pentylpyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3(2H)-furanone, guaiacol, 3-hydroxy-4,5-dimethyl-2(5H)-furanone, 3-hydroxy-4-methyl-5-ethyl-2(5H)-furanone, cinnamaldehyde, cinnamyl alcohol, methyl salicylate, isopulegol and (not explicitly stated here) stereoisomers, enantiomers, positional isomers, diastereomers, cis/trans isomers or epimers of these substances.

Vitamins

In another embodiment of the present invention, the food additives may include vitamins, as another optional group of additives. Vitamins have exceedingly varied mechanisms of biochemical action. Some act similarly to hormones and regulate the metabolism of minerals (e.g. vitamin D), or act on the growth of cells and tissue and on cellular differentiation (e.g. some forms of vitamin A). Others are antioxidants (e.g. vitamin E and under certain circumstances also vitamin C). The largest number of vitamins (e.g. the B vitamins) are precursors of enzyme co-factors, which support enzymes in the catalysis of certain metabolic processes. In this connection, vitamins may sometimes be tightly bound to the enzymes, for example as part of the prosthetic group: an example of this is biotin, which is a part of the enzyme that is responsible for the synthesis of fatty acids. Vitamins may on the other hand also be bound less strongly and then act as co-catalysts, for example as groups that can easily be split off, and that transport chemical groups or electrons between the molecules. Thus, for example, folic acid transports methyl, formyl and methylene groups into the cell. Although their support in enzyme-substrate reactions is well known, their other properties are also of great importance for the body.

In the context of the present invention, substances contemplated as vitamins include those selected from the group consisting of
vitamin A (retinol, retinal, beta-carotene),
vitamin B₁ (thiamine),
vitamin B₂ (riboflavin),
vitamin B₃ (niacin, nicotinamide),
vitamin B₅ (pantothenic acid),
vitamin B₆ (pyridoxine, pyridoxamine, pyridoxal),
vitamin B₇ (biotin),
vitamin B₉ (folic acid, folinic acid),
vitamin B₁₂ (cyanocobalamin, hydroxocobalamin, methylcobalamin),
vitamin C (ascorbic acid),
vitamin D (cholecalciferol),
vitamin E (tocopherols, tocotrienols) and
vitamin K (phylloquinone, menaquinone).

The preferred vitamins are, in addition to ascorbic acid, the tocopherols group.

Prebiotic Substances

In another embodiment of the invention, the preparations may further contain prebiotic substances (prebiotics). Prebiotics are defined as indigestible food constituents whose ingestion stimulates the growth or the activity of a number of useful bacteria in the colon.

Fructooligosaccharides.

Fructooligosaccharides, or FOS for short, comprise—in particular—short-chain representatives with 3 to 5 carbon atoms, for example D-fructose and D-glucose. FOS, also called neosugars, are produced commercially on the basis of sucrose and the enzyme fructosyl transferase obtained from fungi. FOS support in particular the growth of bifidobacteria in the gut and are marketed, mainly in the USA, together with probiotic bacteria in various functional foodstuffs.

Inulins.

Inulins belong to a group of naturally occurring fructose-containing oligosaccharides. They belong to a class of carbohydrates called fructans. They are obtained from the roots of the chicory plant (Cichorium intybus) or so-called Jerusalem artichokes. Inulins consist mainly of fructose units and typically have a glucose unit as end group. The fructose units are linked together via a beta-(2-1)glycosidic bond. The average degree of polymerization of inulins that find application as prebiotics in the food industry is 10 to 12. Inulins also stimulate the growth of bifidobacteria in the colon.

Isomaltooligosaccharides.

This group is a mixture of alpha-D-linked glucose oligomers, including isomaltose, panose, isomaltotetraose, isomaltopentaose, nigerose, kojibiose, isopanose and higher branched oligosaccharides. Isomaltooligosaccharides are produced by various enzymatic routes. They also stimulate the growth of bifidobacteria and lactobacilli in the colon. Isomaltooligosaccharides are used especially in Japan as food additives in functional foodstuffs. They are now also being used more widely in the USA.

Lactilol.

Lactilol is the disaccharide of lactulose. It is used medically against constipation and in hepatic encephalopathy. Lactilol is used as a prebiotic in Japan. It resists breakdown in the upper digestive tract, but is fermented by various intestinal bacteria, which leads to an increase in the biomass of bifidobacteria and lactobacilli in the gut. Lactilol is also known by the chemical name 4-O-(beta-D-galactopyranosyl)-D-glucitol. The medical applications of lactilol in the USA are limited owing to lack of research; in Europe it is used preferably as a sweetener.

Lactosucrose.

Lactosucrose is a trisaccharide that is made up of D-galactose, D-glucose and D-fructose. Lactosucrose is produced by enzymatic transfer of the galactosyl residue in lactose to sucrose. It is not broken down in the stomach or in the upper part of the intestinal tract and is consumed exclusively by bifidobacteria for growth. From the physiological standpoint, lactosucrose acts as a stimulator for the growth of the intestinal flora. Lactosucrose is also known as 4G-beta-D-galactosucrose. It is widely used in Japan as a food additive and as a constituent of functional foods, in particular also as an additive for yoghurts. Lactosucrose is currently also being tested in the USA for similar applications.

Lactulose.

Lactulose is a semi-synthetic disaccharide composed of D-lactose and D-fructose. The sugars are linked via a beta-glycosidic bond, which makes them resistant to hydrolysis by digestive enzymes. Instead, lactulose is fermented by a limited number of intestinal bacteria, which leads to growth especially of lactobacilli and bifidobacteria. In the USA, lactulose is a prescription medicine against constipation and hepatic encephalopathy. In Japan, however, it is sold freely as a food additive and constituent of functional foods.

Pyrodextrins.

Pyrodextrins comprise a mixture of glucose-containing oligosaccharides, which are formed in the hydrolysis of starch. Pyrodextrins promote the proliferation of bifidobacteria in the colon. They too are not broken down in the upper part of the intestine.

Soya Oligosaccharides.

This is a group of oligosaccharides that occur essentially only in soya beans and additionally in other beans and peas. The two main representatives are the trisaccharide raffinose and the tetrasaccharide stachyose. Raffinose is composed of one molecule each of D-galactose, D-glucose and D-fructose. Stachyose consists of two molecules of D-galactose and one molecule each of D-glucose and D-fructose. Soya oligosaccharides stimulate the growth of bifidobacteria in the colon and are already used in Japan as food additives and in functional foods. They are currently being tested in the USA for this application.

Transgalactooligosaccharides.

Transgalactooligosaccharides (TOS) are mixtures of oligosaccharides based on D-glucose and D-galactose. TOS are produced starting from D-lactose with the aid of the enzyme betaglucosidase from Aspergillus oryzae. Like many other prebiotics, TOS are also stable in the small intestine and stimulate the growth of bifidobacteria in the colon. TOS are already marketed as food additives both in Europe and in Japan.

Xylooligosaccharides.

Xylooligosaccharides contain beta-1,4-linked xylose units. The degree of polymerization of the xylooligosaccharides is between 2 and 4. They are obtained by enzymatic hydrolysis of the polysaccharide xylan. They are already marketed as food additives in Japan; in the USA they are still in the phase of testing.

Biopolymers.

Suitable biopolymers also contemplated as prebiotics, for example beta-glucans, are notable in that they are produced on a plant basis; for example, possible raw material sources are cereals such as oats and barley, but also fungi, yeasts and bacteria. Microbially produced cell wall suspensions or whole cells with high beta-glucan content are also suitable. Residual fractions of monomers have 1-3 and 1-4 or 1-3 and 1-6 linkages, and the content may vary widely. Preferably, beta-glucans are obtained on the basis of yeasts, especially Saccharomyces, in particular Saccharomyces cerevisiae. Other suitable biopolymers are chitin and chitin derivatives, especially oligoglucosamine and chitosan, which is a typical hydrocolloid.

Galactooligosaccharides (GOS).

Galactooligosaccharides are produced by the enzymatic transformation of lactose, a component of bovine milk. GOS generally comprise a chain of galactose units, which are formed by successive transgalactosylation reactions, and which have a terminal glucose unit. Terminal glucose units are mostly formed by early hydrolysis of GOS. The degree of polymerization of the GOS may fluctuate quite widely and ranges from 2 to 8 monomer units. A range of factors determine the structure and the order of the monomer units: the enzyme source, the starting material (lactose concentration and origin of the lactose), the enzymes participating in the process, conditions during processing, and the composition of the medium.

Antioxidants

Both natural and artificial antioxidants are used in the food industry. Natural and artificial antioxidants differ primarily in that the former occur naturally in food and the latter are produced artificially. Thus, natural antioxidants, if they are to be used as food additives, are obtained for example from vegetable oils. Vitamin E—also known as tocopherol—is for example often produced from soya oil. Synthetic antioxidants such as propyl gallate, octyl gallate and dodecyl gallate are in contrast obtained by chemical synthesis. The gallates may trigger allergies in sensitive persons. Other antioxidants usable in compositions of the present invention are: sulphur dioxide, E 220 sulphites sodium sulphite, E 221 sodium hydrogen sulphite, E 222 sodium bisulphite, E 223 potassium bisulphite, E 224 calcium sulphite, E 226 calcium hydrogen sulphite, E 227 potassium hydrogen sulphite, E 228 lactic acid, E 270 ascorbic acid, E 300 sodium L-ascorbate, E 301 calcium L-ascorbate, E 302 ascorbic acid ester, E 304 tocopherol, E 306 alpha-tocopherol, E 307 gamma-tocopherol, E 308 delta-tocopherol, E 309 propyl gallate, E 310 octyl gallate, E 311 dodecyl gallate, E 312 isoascorbic acid, E 315 sodium isoascorbate, E 316 tertiary-butylhydroquinone (TBHQ), E 319 butylated hydroxyanisole, E 320 butylated hydroxytoluene, E 321 lecithin, E 322 citric acid, E 330 salts of citric acid (E 331 & E 332) sodium citrate, E 331 potassium citrate, E 332 calcium disodium EDTA, E 385 diphosphates, E 450 disodium diphosphate, E 450a trisodium diphosphate, E 450b tetrasodium diphosphate, E 450c dipotassium diphosphate, E 450d tripotassium diphosphate, E 450e dicalcium diphosphate, E 450f calcium dihydrogen diphosphate, E 450g triphosphates, E 451 pentasodium triphosphate, E 451a pentapotassium triphosphate, E 451b polyphosphate, E 452 sodium polyphosphate, E 452a potassium polyphosphate, E 452b sodium calcium polyphosphate, E 452c calcium polyphosphate, E 452d tin(II) chloride, E 512.

Fruit and Vegetable Preparations

The fruit preparations may be, for example, jam, fruit spread, preserve or fruit jelly, and also fruit purées or fruit juice concentrates. Jam is the traditional name for a spread for bread that is produced from fruits that are boiled with sugar, without pieces of fruit remaining visible in the finished product. A preserve, however, is a product in which the pieces of fruit are still visible. Fruit jellies contain pectin, which is present in numerous fruits, particularly in apples. In order to remove it from the cell walls, pectin-rich fruits are boiled with sugar. The sugar draws water from the cells, in the course of which the cell walls are destroyed and the pectin can be more easily released. If there is sufficient sugar in the solution, the liberated water binds to the sugar—the pectin molecules can then only react with one another and no longer with the water. In order that these molecules join on cooling to form a framework, in which the water becomes “trapped”, however, they must be present at a sufficiently high concentration, and the solution must be acidic, since otherwise the pectin molecules repel one another (as a result of ionization). The ideal pH is 3.3. In German food law, jellies comprising aqueous extracts of fruits or thickened fruit juice are referred to as simple jelly (fruit juice fraction of at least 35%) or extra jelly (fruit juice fraction of at least 45%). A typical example of a vegetable preparation is powdered spinach.

Flavourings

The selection of the flavourings is not critical and is guided solely by the desired direction of flavour. Preferred flavourings are those which convey an odorous impression of sweetness, with the further flavouring or flavourings that convey an odorous impression of sweetness being preferably selected from the group consisting of: vanillin, ethylvanillin, ethylvanillin isobutyrate (i.e. 3-ethoxy-4-isobutyryloxybenzaldehyde), vanilla extracts, furaneol (2,5-dimethyl-4-hydroxy-3(2H)-furanone) and derivatives (e.g. homofuraneol, 2-ethyl-4-hydroxy-5-methyl-3(2H)-furanone), homofuronol (2-ethyl-5-methyl-4-hydroxy-3(2H)-furanone and 5-ethyl-2-methyl-4-hydroxy-3(2H)-furanone), maltol and derivatives (e.g. ethyl maltol), coumarin and derivatives, gamma-lactones (e.g. gamma-undecalactone, gamma-nonalactone), delta-lactones (e.g. 4-methyl deltalactone, massoia lactone, deltadecalactone, tuberolactone), methyl sorbate, divanillin, 4-hydroxy-2(or 5)-ethyl-5(or 2)-methyl-3(2H)-furanone, 2-hydroxy-3-methyl-2-cyclopentenones, 3-hydroxy-4,5-dimethyl-2(5H)-furanone, fruit esters and fruit lactones (e.g. n-butyl acetate, isoamyl acetate, ethyl propionate, ethyl butyrate, n-butyl butyrate, isoamyl butyrate, ethyl 3-methyl butyrate, ethyl n-hexanoate, allyl n-hexanoate, n-butyl n-hexanoate, ethyl n-octanoate, ethyl 3-methyl-3-phenylglycidate, ethyl 2-trans-4-cis-decadienoate), 4-(p-hydroxyphenyl)-2-butanone, 1,1-dimethoxy-2,2,5-trimethyl-4-hexane, 2,6-dimethyl-5-hepten-1-al, 4-hydroxycinnamic acid, 4-methoxy-3-hydroxycinnamic acid, 3-methoxy-4-hydroxycinnamic acid, 2-hydroxycinnamic acid, 2,4-dihydroxybenzoic acid, 3-hydroxybenzoic acid, 3,4-dihydroxybenzoic acid, vanillic acid, homovanillic acid, vanillomandelic acid and phenylacetaldehyde.

Food Colourings

Food colourings, or colourings for short, are food additives for colouring foodstuffs. Colourings are subdivided into the groups of the natural colours and synthetic colours. The nature-identical colourings are likewise of synthetic origin. The nature-identical colourings are synthetic copies of colouring substances that occur in nature. Suitable colourings for use in the present composition are selected from the following: curcumin, E 100 riboflavin, lactoflavin, vitamin B2, E 101 tartrazine, E 102 quinoline yellow, E 104 yellow-orange S, yellow-orange RGL, E 110 cochineal, carminic acid, true carmine, E 120 azorubine, carmoisine, E 122 amaranth, E 123 cochineal red A, Ponceau 4 R, Victoria scarlet 4 R, E 124 erythrosine, E 127 Allura red AC, E 129 Patent blue V, E 131 indigotin, indigo carmine, E 132 Brilliant Blue FCF, Patent Blue AE, Amido Blue AE, E 133 chlorophylls, chlorophyllins, E 140 copper complexes of chlorophylls, copper-chlorophyllin complex, E 141 Brilliant Acid Green, Green S, E 142 caramel colour, E 150 a sulphite lye caramel colour, E 150 b ammonia caramel colour, E 150 c ammonium sulphite caramel colour, E 150 d Brilliant Black FCF, Brilliant Black PN, Black PN, E 151 vegetable charcoal, E 153 Brown FK, E 154 Brown HT, E 155 carotene, E 160 a annatto, bixin, norbixin, E 160 b capsanthin, capsorubin, E 160 c lycopene, E 160 d beta-apo-8′-carotenal, apocarotenal, beta-apocarotenal, E 160 e beta-apo-8′-carotenoic acid ethyl ester (C30), apocarotene esters, beta-carotenoic esters, E 160 f lutein, xanthophyll, E 161 b canthaxanthin, E 161 g betanin, beet red, E 162 anthocyans, E 163 calcium carbonate, E 170 titanium dioxide, E 171 iron oxides, iron hydroxides, E 172 aluminium, E 173 silver, E 174 gold, E 175 lithol rubine BK, rubine pigment BK, E 180.

One preferred embodiment of the present invention uses initial preparations which may have the following composition:
(i) about 25 to about 60 wt % and more particularly about 30 to about 50 wt % of carbohydrates,
(ii) about 5 to about 30 wt % and more particularly about 10 to about 20 wt % of lipids,
(iii) about 25 to about 50 wt % and more particularly about 30 to about 40 wt % of milk products,
(iv) about 0.1 to about 10 wt % and more particularly about 0.2 to about 1.0 wt % of emulsifiers, and optionally
(v) about 1 to about 10 wt % and more particularly about 2 to about 4 wt % of additives selected from the group consisting of sweeteners, acid regulators, thickeners, vitamins, prebiotic substances, antioxidants, fruit preparations, nuts, chocolates, flavourings and food colourings and also mixtures thereof,
   with the proviso that the quantity figures add up, optionally with water, to 100 wt %.

Temperature Treatment

In the first step for producing the processed powders, the starting materials are mixed. The initial mixture consists necessarily of ingredients (i) to (iv) and may also have further ingredients from group (v), where it is not advisable to add these ingredients at other points in the method, in order to avoid any unwanted temperature exposure. Mixing takes place in the presence of an amount of water sufficient to generate a pumpable slurry without unnecessarily burdening the method in terms of energy as a result of an excessively high water content.

After mixing has taken place there is a first temperature treatment, which is preferably a conventional pasteurization, meaning that the mixture is heated to 70 to 100° C., more particularly for 15 seconds to at least 72° C. This operation may take place, for example, in a conventional heat exchanger, especially a plate-type heat exchanger.

Homogenization

After the temperature treatment there is the homogenization. This is accomplished preferably in a high-pressure homogenizer in the range from about 30 to about 80° C. and at a pressure of 50 to 150 bar. If desired, the homogenized intermediate can be subjected to a second temperature treatment, prior to the concentration, in the course of which it is heated for a few seconds to at least 100° C.

Concentration

Next comes the concentration of the product, which may be carried out in any apparatus which is heatable and has a stirrer and a venting device for steam. The product at this stage is adjusted to a solids content of at least 70 wt %, preferably at least 80 wt % and more particularly at least 90 wt %.

Crystallization

The crystallization may take place typically in a stirred tank or else, for example, in a scraped-surface cooler or, preferably, a vacuum cooler. The concentrate is cooled to about 20 to about 40° C. and slowly induced to crystallize, and is then either discharged as a solid or simply scraped off. It can be advantageous to add seed crystals, lactose for example, to the concentrate. A particular advantage of this step is that the lactose present in the milk products likewise undergoes crystallization, thereby considerably improving the storage stability in respect of a reduced hygroscopicity. This procedure generates crystals having a diameter of not more than 20 μm, which do not evoke any sensory defects (sandiness).

The substances which form component (v) can be added after the temperature treatment, but preferably after the crystallization.

Vacuum Belt Drying

Vacuum belt dryers consist essentially of a housing with built-in, product-transporting conveyor belts which are drawn over heating assemblies. An automatic belt regulation system ensures precise belt running. The belts are run in parallel in one or more planes, and a metering pump with an oscillating nozzle is assigned to each of the belts, and applies the product in the form of foam in accordance with the invention. The applicant has found that this particular mode of metering means that products are ultimately obtained that are significantly superior to those, for example, from spray drying in terms of the particle size distribution and hence solubility and sensory qualities. A further factor is the shift in boiling point under vacuum, which ensures that the evaporation temperature drops and the product can be dried more gently. The principle has been known for as long as since the middle of the 1950s (cf. DE 948678 A, BAYER).

The crystallization intermediates, which still contain water, pass, during drying, through a high-viscosity phase which is in many cases also sticky, as a result of which a dry cake forms on the belt at the end of the drying course, as a result of the formation of steam bubbles in the product. While the belts initially run via a plurality of heating zones that are adjustable independently of one another, the last zone is a cooling zone, in which the dry cake is cooled to a state of brittle fragility, is broken up with a guillotine, and is comminuted in a crusher or granulator.

The vacuum belt dryer may be heated with steam, pressurized water or thermal oil; the vacuum is generated generally by a combination of steam jet pump with downstream condenser and water ring vacuum pump. In the heating zones, the temperature in this case is usually about 60 to about 140° C. and more particularly about 70 to about 120° C., and the pressure is generally about 5 to about 40 mbar and more particularly about 10 to about 30 mbar. The heating zones, as already mentioned, can be controlled individually, and so it is possible for any desired temperature profile to be applied. Within the cooling zone, temperatures of about 20 to about 30° C. then prevail. In principle drying should be carried out at extremely low temperatures, in order to minimize the formation of insoluble particles. A structural alternative would also be, for example, a vacuum drying cabinet.

The resultant powders can subsequently be ground to the desired particle size and bagged.

Commercial Usefulness

A further subject of the invention relates to the use of the food composition in powder form as an instant powder for producing ice-cream.

### EXAMPLES

### Inventive Example 1

The initial preparation used was a preparation composed of 1600 g of skimmed milk, 125 g of vegetable fat and 12 g of stabilizer/emulsifier mixture. This mixture was homogenized at 55 to 60° C. and at a pressure of 100 to 150 bar and then pasteurized at 72° C. for 15 seconds. Sugar and glucose were then added to the homogeneous mass. A second heating followed, to 100° C. The resulting product was then evaporated down in a concentrator to a dry mass of 80 wt %. The crystallized mass was mixed with 7 g of vanilla flavour and then introduced onto a vacuum belt dryer, on which it was freed gently from residual water at 40° C. and 20 mbar. The resulting powder was subsequently ground and dispensed.

### Comparative Example C1

Inventive example 1 was repeated, but the vacuum belt drying was replaced by spray drying at 180° C.

Assessment of the Powders

The solubility of the powders in water (g/litre) and also the visual appearance (1=no discolorations, 2=slight discolorations, 3=burnt particles) and the sensory properties (sandy taste: 3=pronounced, 2=present, 1=imperceptible) were assessed by a panel consisting of three experienced testers. The results are summarized in Table 1. They show that the products obtainable according to the method of the invention are significantly superior in solubility, appearance and sensory qualities to the products of the prior art.

TABLE 1
Solubility and sensory qualities

| | Inventive | Comparative |
|---|---|---|
| Examples | example 1 | example C1 |
| Time taken for 180 g of product to dissolve in | 8 s | 25 s |
| 500 ml of water | | |
| Colour quality | 1 | 3 |
| Sensory assessment | 1 | 3 |
| Solubility in ml of sediment | <0.1 | >5* |

*Product had caked as a result of overheated sugar

1. A food composition in powder form, obtained by subjecting a preparation comprising
(i) carbohydrates,
(ii) lipids,
(iii) milk products and
(iv) emulsifiers
to a process comprising the steps of:
(a) subjecting said preparation to a temperature treatment,
(b) homogenizing the temperature-treated product of step (a),
(c) concentrating the homogenized product of step (b),
(d) crystallizing the concentrated product of step (c),
(e) and freeing the crystallized product of step (d) from residual water by a vacuum belt dryer.

2. The composition of claim 1, further comprising sweeteners, acidity regulators, thickeners, vitamins, prebiotic substances, antioxidants, fruit preparations, nuts, chocolates, flavourings, cocoa, honey and/or food colourings.

3. A method for producing a food composition in powder form, comprising of the steps of
(a) providing a preparation comprising
(i) carbohydrates,
(ii) lipids,
(iii) milk products, and
(iv) emulsifiers
(b) subjecting said preparation to a temperature treatment,
(c) homogenizing the temperature-treated product of step (b),
(d) concentrating the homogenized product of step (c),
(e) crystallizing the concentrated product of step (d),
(f) and freeing the crystallized product of step (e) from residual water by a vacuum belt dryer.

4. The method of claim 3, wherein said carbohydrates forming component (i) are selected from the group consisting of glucose, fructose dextrose, dextrins and mixtures thereof.

5. The method of claim 3, wherein said lipids forming component (ii) are selected from the group consisting of hydrogenated or partially hydrogenated or unhydrogenated vegetable fats and mixtures thereof.

6. The method of claim 3, wherein said milk products forming component (iii) are selected from the group consisting of skimmed milk, whole milk, semi-skimmed milk, cream, whey, whey protein concentrates and mixtures thereof.

7. The method of claim 3, wherein said emulsifiers forming component (iv) are selected from the group consisting of whole egg, mono- and diglycerides of edible fatty acids and egg yolk and mixtures thereof.

8. The method of claim 3, wherein said preparation comprises
(i) about 25 to about 60 wt % of carbohydrates,
(ii) about 5 to about 30 wt % of lipids,
(iii) about 25 to about 50 wt % of milk products,
(iv) about 0.1 to about 10 wt % of emulsifiers, and optionally
(v) about 1 to about 10 wt % of additives selected from the group consisting of sweeteners, acidity regulators, thickeners, vitamins, prebiotic substances, antioxidants, fruit preparations, nuts, chocolates, flavourings and food colourings and also mixtures thereof,
with the proviso that the quantity figures add up, optionally with water, to 100 wt %.

9. The method of claim 3, wherein said temperature treatment takes place at about 70 to about 100° C.

10. The method of claim 3, wherein said homogenization takes place at temperatures in the range from about 30 to about 80° C. and optionally under pressure.

11. The method of claim 3, wherein said homogenized product of step (c) is subjected to a second temperature treatment prior to the concentration.

12. The method of claim 3, wherein said homogenized product of step (c) is concentrated to a solids content of at least 70 wt %.

13. The method of claim 3, wherein said vacuum belt drying takes place at a temperature in the range from about 60 to about 140 CC and at a reduced pressure of about 5 to about 40 mbar.

14. The method of claim 8, wherein the substances which form component (v) are added after the temperature treatment and/or after the crystallization.

15. (canceled)

16. A method for producing ice-cream, comprising the steps of:
(i) providing an instant powder composition obtained according to claim 3,
(ii) dissolving said powder composition in an amount of water to form an aqueous solution, and
(iii) freezing said aqueous solution to obtain ice-cream.
